(19) United States
(12) Patent Application Publication
(10) Pub. No.: US 2008/0033863 A1
(43) Pub. Date: Feb. 7, 2008

(54) Process and method for establishing credit default swap indices on defined economic sectors to support the creation, trading and clearing of credit derivative instruments

(76) Inventors: Howard Simons, Glenview, IL (US); Bradley J. McGill, Birmingham, AL (US); Daniel A. Sanabria, Birmingham, AL (US)

Correspondence Address: Daniel H. Golub, 1701 Market Street, Philadelphia, PA, 19103, US

(21) Appl. No.: 11/645,230

(22) Filed: Dec. 22, 2006

Related U.S. Application Data
(60) Provisional application No. 60/754,073, filed on Dec. 26, 2005.

(51) Int. Cl. G06Q 40/00

(52) U.S. Cl. 705/37

(57) ABSTRACT

A method for establishing a credit default swap index on a defined economic sector. A reference economic sector is identified by an index provider. A multi-credit corporate index is established for the reference economic sector. Individual credit default swap (CDS) transactions and the multi-credit corporate index are used to compile an industry sector CDS index for the reference economic sector. At least one issue or credit reference in the industry sector CDS index is weighted differently, relative to the weight of other issues or credit references in the industry sector CDS index. Structured credit instruments are issued by a dealer based on the industry sector CDS sector index. Trading positions with respect to the structured credit instruments are monitored by a dealer. The structured credit instruments are settled against the industry sector CDS index.

### CROSS REFERENCE TO RELATED APPLICATIONS

This application claims priority to U.S. provisional application Ser. No. 60/754,073 filed on Dec. 26, 2005 entitled “Process and Method for Establishing Customized Credit Default Swap Indices on Defined Industry Sectors to support the Creation, Trading and Clearing of Credit Derivative Instruments,” incorporated herein by reference.

### FIELD OF THE INVENTION

The present invention relates to a process and method for creating and establishing credit default swap indices on defined economic sectors, to facilitate the distribution and clearing of credit derivative instruments.

### BACKGROUND OF THE INVENTION

A “derivative instrument” (also referred to as a derivative) in the securities, trading, insurance, and economics communities includes securities or contracts whose value is linked to or derived from factors such as the value of an underlying security, index, asset or liability, or on a feature of such an underlying security such as interest rates or convertibility into some other security. Financial futures on stock indices or options to buy and sell such futures contracts are highly popular exchange-traded financial derivatives. Derivatives may also be traded on commodities, insurance events, and other events, such as the weather.

In the past 15 years the growth in derivatives trading has been enormous. Corporations, financial institutions, and national governments and agencies are all active in the derivatives markets to better manage asset and liability portfolios, hedge financial market risk, and minimize costs of capital funding. Money managers also use derivatives to hedge and undertake economic exposure where there are inherent risks, such as risks of fluctuation in interest rates, foreign exchange rates, convertibility into other securities, or outstanding purchase offers for cash or exchange offers for cash or securities.

A “listed” derivative is traded on exchanges, such as the option and futures contracts traded on the Chicago Board of Trade, whereas an off-exchange or over-the-counter derivative is traded between two or more derivative counterparties. On the major exchanges orders are transmitted to member brokers who execute the orders and usually balance or hedge their own portfolio of derivatives to suit their own risk and return criteria. Hedging is usually accomplished by trading in the derivatives' underlying securities or contracts or in similar derivatives.

Listed derivatives, and particularly futures and options on futures, share many common characteristics. The contract specifications for a given contract are fixed, with standardized notional values, trading hours, expirations and tick sizes. The trading and clearing processes are also universal. In virtually all implementations, a broker, often called a Futures Commission Merchant (FCM), will submit an order to an exchange. The exchange will expose this order to the broader market, either on the floor of the exchange or electronically on a trading platform. Once a match is made between buyer and seller, the trade is submitted to a clearing facility for processing. The clearing facility will maintain this position on its books, report on it to each party, and collect and hold collateral to guarantee performance by each party.

Alternatively, derivatives can trade on a decentralized over-the-counter market without a physical meeting place or centralized electronic medium. In an OTC environment, participating dealers directly interact arranging bilateral agreements where each participant will seek to balance their active portfolios of derivatives in accordance with the trader's risk management guidelines and profitability criteria. OTC derivatives can be structured according to the counterparties' particular needs and generally offer a more ample flexibility than listed contracts. In addition, a greater portion of liquidity is usually concentrated around a group of market participants including broker/dealers, investment banks, and institutional investors.

Over-the-counter or listed interest rate or equity derivatives are contracts that are settled based on movements in prices of bonds and levels of interest rates, or values of equity, respectively, without transferring the underlying stock. On the other hand, a credit derivative is a bilateral contract between parties related to the returns generated by a credit asset, such as a bond, loan or collateralized debt obligation, often without requiring the transfer of the underlying asset itself.

The purpose of a credit derivative contract is to transfer the risk inherent in a credit transaction. A market participant who is exposed to the credit risk of a corporation can hedge their risk exposure by buying protection in the credit derivatives market. Of all the credit derivatives, credit default swap (CDS) contracts are among the most heavily traded, and have proven to be the most popular instruments used in recent years to manage this type of risk. A credit default swap is a financial guarantee whereby the seller agrees, for a premium, to compensate the protection buyer upon the happening of a specified event, such as a default, bankruptcy, debt restructuring, etc. An investor can take a position on credit by the use of credit default swaps or an index based on these swaps. The appearance of credit indices has contributed to the development and rapid growth of the credit default swap business.

The recent development of credit derivatives has contributed to the stability of the banking system by allowing banks to measure and manage their credit risks more effectively. During 2005, notional amounts outstanding of credit default swaps more than doubled to $13.6 trillion.

The largest banks have found single-name credit default swaps a highly attractive mechanism for reducing exposure. During 2005, single-name CDS also doubled their notional amount outstanding to $10.2 trillion.

In addition, growth was particularly strong in multi-name contracts, including basket and index trades. Their increasing popularity coincides with the emergence of widely-recognized CDS indices. Total notional value traded during 2005 totaled $3.4 trillion, representing a 172% increase from the previous year.

Within the CDS market itself, obligations are repackaged into structures called collateralized debt obligations, or CDOs. These instruments are ranked into tranches by their safety and security, with the highest-yielding and most risky instruments referred to as the “equity tranche.” The relative behavior of each tranche has been modeled by “correlation traders.” Correlation trading both between tranches of a single issuer's CDOs and between similar tranches of different firms is one of the fastest-growing segments of the credit market.

In 2003, two securities dealers initiated the development of TRAC-X and iBoxx, which represent CDS indices based on equally weighted baskets of credit default swaps. These were merged into the denominated iTraxx CDS indices in Europe. A US version of these indices, the Dow Jones North American Investment Grade five year CDX indices, track the credit profile of baskets composed of 125 corporate credits. Each issue is weighted equally in the index at 0.8%. Although a sector field is provided for each issue listing, no use of the sector field is made in compiling the Dow Jones CDX indices, nor do such indices pay particular focus on equitable sector representation, given the complete absence of entries from both the Technology and Healthcare sectors, which underlie two of the S&P Select Sector SPDRs (define), XLK and XLV, respectively.

### SUMMARY OF THE INVENTION

Based on the linked fortunes of firms in the same economic sectors of the market and the linkages between credit default risk and option implied volatility, which both measure corporate stress and uncertainty, the present inventors believe that credit indices linked to instruments already traded actively would be useful. Based on the acceptance of different-weighted economic sector ETFs, either price-weighted or capitalization-weighted, and the active trade in their options, the present inventors believe that creation of different-weighted CDS indices would be useful. The iTRAXX indices, with their equal-weighting schemes and their construction without sector specificity in mind do not meet this demand. Only those instruments designed to meet the weighting of existing liquid exchange-traded funds (ETF) and ETF options and which are composed of a similar sector-specific mix of liquid CDS instruments can meet the needs of correlation traders, option traders, and index arbitrageurs.

With the tremendous volume and rapid growth of the credit default swap business, and the prevalence of new technologies and broadly dispersed trading platforms and market participants, the market should be able to achieve a viable successful venue on which to transact derivatives based on a specific sectored credit default swap index. The present inability of the market to do so appears to be due to the absence of an effective process and method for establishing benchmark CDS indices where all the referenced components belong to the same industry field. If such a process and method were available, the novel sectored CDS indices would provide a new set of trading opportunities bridging the worlds of corporate bonds and credit default swaps, sector ETFs and index options, and support different market participants that currently do not benefit from the ability of credit default swap indices covering specific industry sectors. The liquidity concentration and contract flexibility features of over-the-counter markets may favor the use of an OTC implementation for derivatives traded against the sector CDS indices described herein in which trading during early stages of the model is likely to be processed away from an exchange.

The present disclosure relates to a process and method for creating and establishing customized credit default swap indices on defined industry sectors, to facilitate the distribution and clearing of credit derivative instruments. These subindexes mirror commonly recognized equity economic sector indices by design, with the specific intent of linking the worlds of corporate bonds, commodities, sector exchange-traded funds and options thereon, and individual credit default swaps, with a set of liquid and transparent instruments.

In some embodiments, the weights of each index value are adjusted to reflect only those members of a sector index for which there are CDS quotations. The sector CDS indices will facilitate arbitrage and correlation trading between these other markets and will provide an additional trading instrument in their own right for those seeking a way to trade the credit position of an entire economic sector such as Energy, Utilities or Basic Materials. The derivatives traded against the sectored credit default swap indices described herein may include but are not limited to, for example, futures and options contracts, swaptions (Options on Swaps), basket CDS cash flows, or default swap spreads to include 1^{st} to default, n to default, or all to default event derivatives, and the like. In these endeavors the participating members or agents issuing a credit default swap would first agree to identifying and designating the credit default events, generally including the cases of bankruptcy, situations in which the entities referenced on a credit index would be unable to pay, debt restructuring, repudiation, or any additional events by which the reference entity fails to meet their credit obligations, and the related impact of these events upon the sector indices and products.

The present invention provides a method for establishing a credit default swap index on a defined economic sector. A reference economic sector is identified by an index provider. A multi-credit corporate index is established for the reference economic sector. Individual credit default swap (CDS) transactions and the multi-credit corporate index are used to compile an industry sector CDS index for the reference economic sector. At least one issue or credit reference in the industry sector CDS index is weighted differently, relative to the weight of other issues or credit references in the industry sector CDS index. A percentage weight of each issue or credit reference in the industry sector CDS index is publicly disseminated. A value of the industry sector CDS index is updated on periodic basis. Structured credit instruments are issued by a dealer based on the industry sector CDS sector index. The structured credit instruments include at least one of the following provisions: (i) an obligation of a buyer to pay a periodic premium or a return of the industry sector CDS index to a seller; and (ii) a right by a seller to receive a periodic premium for credit default protection or the return of the industry sector CDS index. Trading positions with respect to the structured credit instruments are monitored by a dealer. The structured credit instruments are settled against the industry sector CDS index.

In some embodiments, the industry sector CDS index is divided into a set of industry sub-sectors. Data used for compiling the industry sector CDS index optionally comprises generic par credit default swap spread (CDS) costs reported for each reference value in the index, if and when available. In some embodiments, the industry sector CDS index is a market capitalization-weighted combination of available credit default swap costs in basis points for all credit references of the reference economic sector. For example, the weight may be divided by a total weight of companies in the reference economic sector. Optionally, each issue or credit reference's percentage weight of the industry sector CDS index on a market capitalization basis is recorded and updated periodically. In other embodiments, the industry sector CDS index is a market capitalization-weighted combination of available credit default swap costs in basis points for all credit references of the reference economic sector. In still further embodiments, the industry sector CDS index is a market price-weighted combination of available credit default swap costs in basis points for all credit references of the reference economic sector. In a specific embodiment, the value of the industry sector CDS index for a given day is equal to a sum across all companies in the reference economic sector for which CDS costs are available of each company's adjusted weight multiplied by each company's CDS cost.

### BRIEF DESCRIPTION OF THE DRAWINGS

In the accompanying drawings:

FIG. 1 includes a schematic illustrating a method for creating and distributing sector credit default swap indices.

FIGS. 2A and 2B illustrate the Global Industry Classification Standard (GICS) currently published by Standard & Poors.

FIGS. 3A and 3B illustrate the Industrial Classification Benchmark (ICB) Industry Structure, currently published by Dow Jones Indexes and FTSE.

### DETAILED DESCRIPTION OF THE INVENTION

For purposes of this application a “credit derivative” refers to privately held negotiable bilateral contracts that allow users to manage their exposure to credit risk. Credit derivatives are financial assets like forward contracts, swaps, and options for which the price is driven by the credit risk of economic agents (private investors or governments).

A “futures exchange” or “derivatives exchange” in the context of the present application refers to a marketplace where futures and options contracts are traded.

For purposes of this application a “swap” means the exchange of one security for another to change the maturity (bonds), quality of issues (stocks or bonds), or because investment objectives have changed, or, in the case of interest rates, an agreement between two parties (known as counterparties) where one stream of future interest payments is exchanged for another based on a specified principal amount.

The term “credit default swap”, “CDS”, “single name credit default swap” or “single name CDS” means a swap designed to transfer the credit exposure of fixed income products between parties. The buyer of a credit swap receives credit protection, whereas the seller of the swap guarantees the credit worthiness of the product. By doing this, the risk of default is transferred from the holder of the fixed income security to the seller of the swap. For example, the buyer of a credit swap will be entitled to the par value of the bond by the seller of the swap, should the bond default in its coupon payments.

Additionally, a “CDS Index” refers to a standard portfolio of single name credit default swaps, which optionally provides credit or default protection to its long buyers.

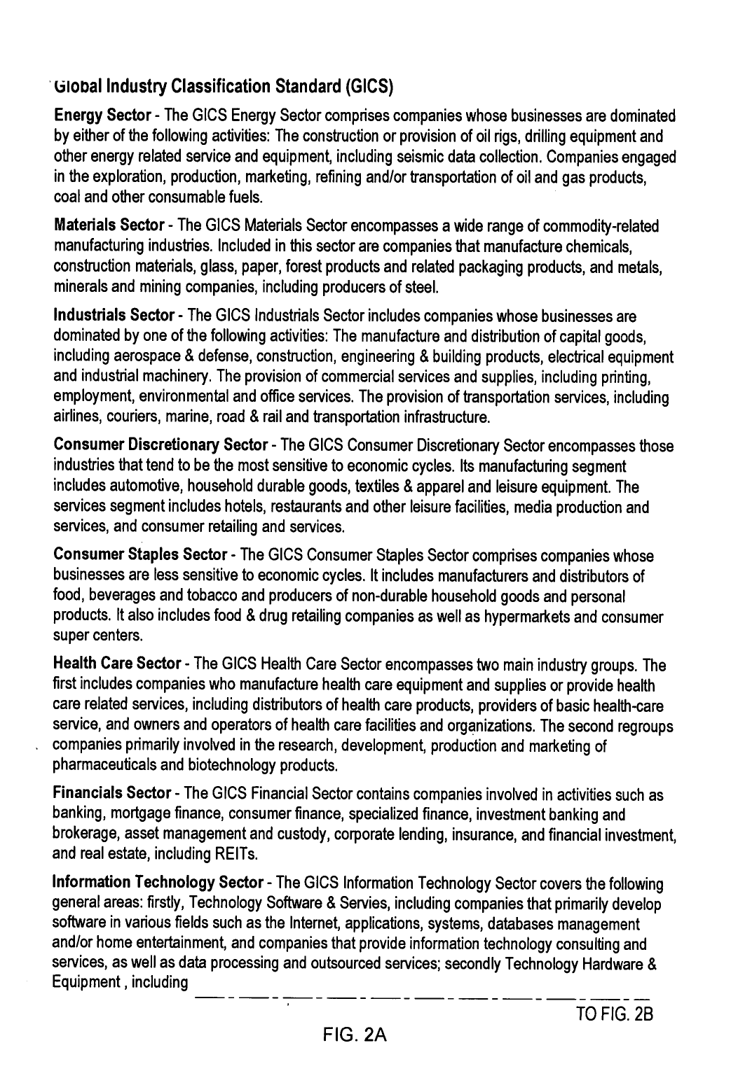

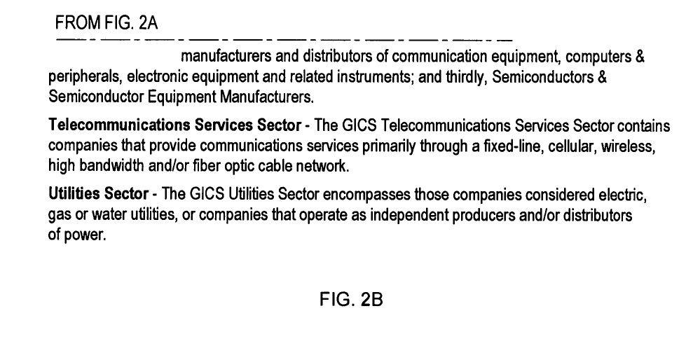

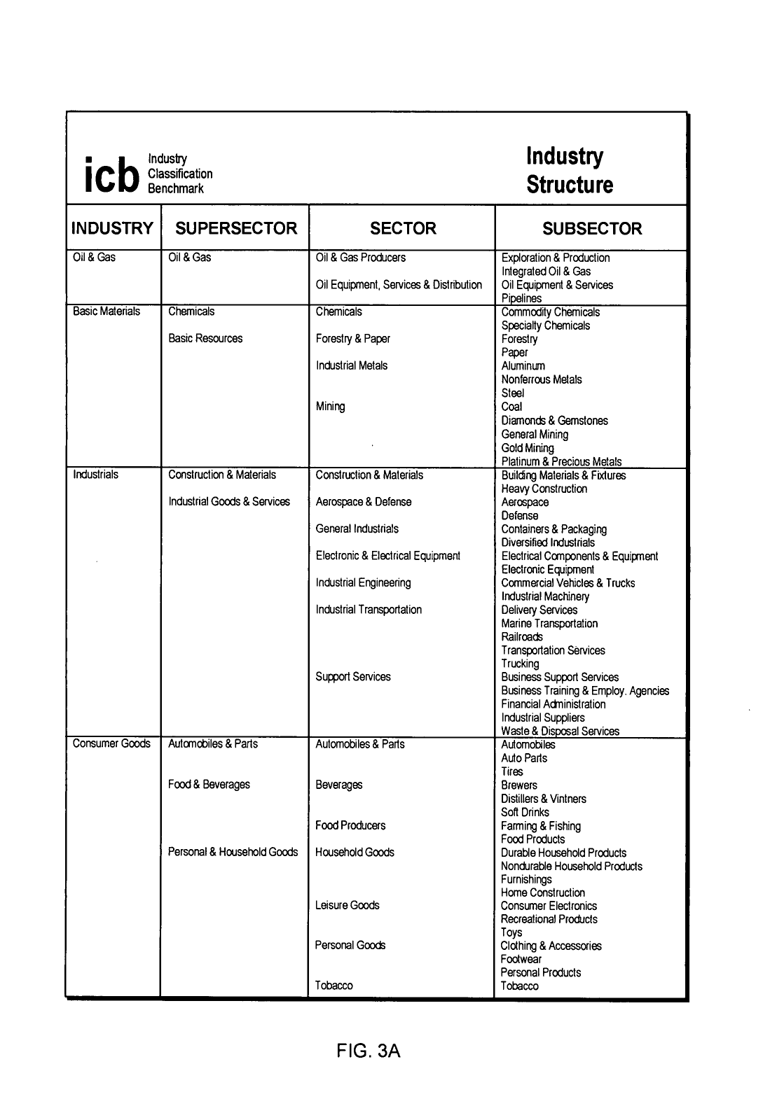

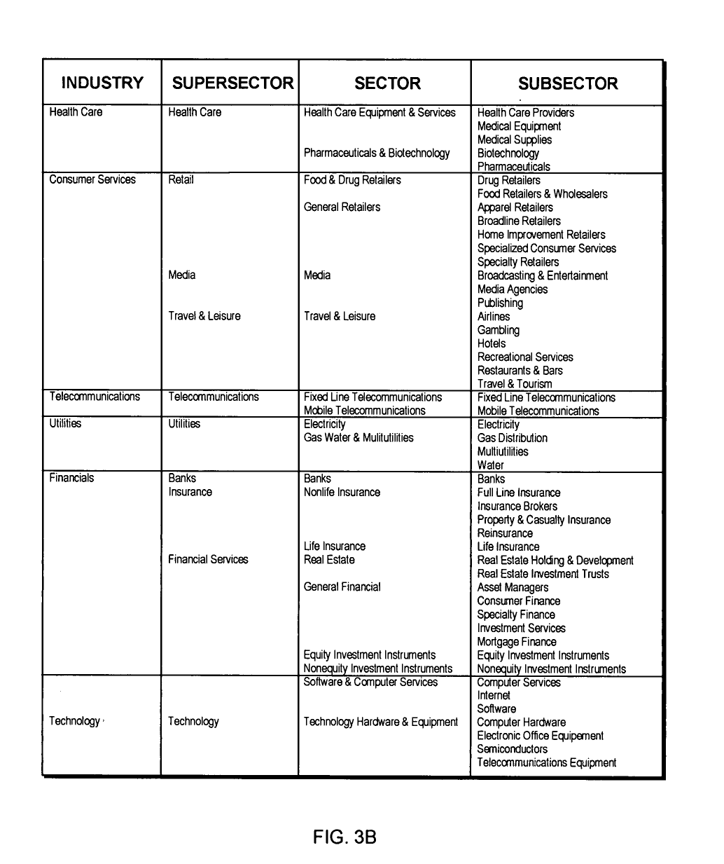

The term “economic sector” means an area of the economy in which businesses share the same or related products or services, or a group of securities or financial instruments as arranged by industry type by an indexing company. In determining whether a given business falls within a particular “economic sector, the credit worthiness of the business, based upon its history of borrowing and repayment, is not considered. One example of a defined set of economic sectors is provided by the Global Industry Classification Standard (GICS), currently published by Standard & Poors, and set forth on FIGS. 2A and 2B. Other examples of defined sets of economic sectors are provided by the Industrial Classification Benchmark (ICB) Industry Structure, currently published by Dow Jones Indexes and FTSE, and set forth on FIGS. 3A and 3B. For the avoidance of doubt, each “industry,” “supersector,” “sector” and “subsector” in the IBC Industry Structure may be considered an “economic sector” for purposes of this disclosure.

The term “multi-credit” in the context of a CDS reference refers to a custom portfolio of credit default swaps agreed upon by the buyer and seller, or a CDS index.

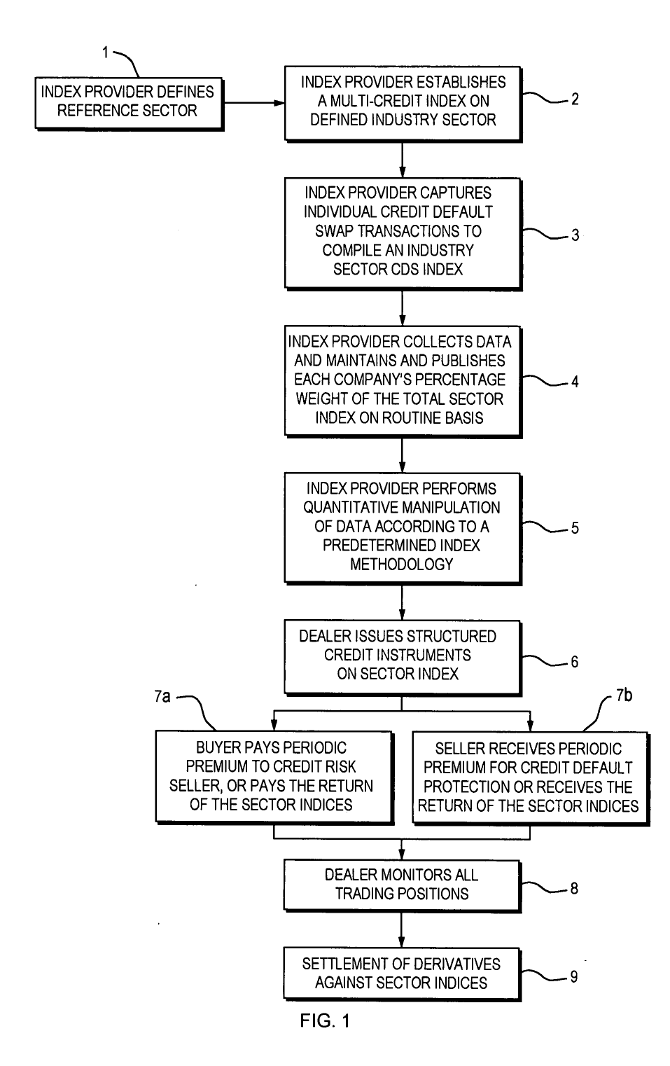

FIG. 1 shows a process and method for creating and establishing customized credit default swap indices on defined economic sectors, to facilitate the distribution and clearing of credit derivative instruments against the default swap indices. Step 1 involves defining multiple economic sectors by an index provider to enable the grouping of a number of credit references of entities according to the entities' sector field. In a preferred embodiment, this credit reference segmentation will be most effective if developed by a recognized provider of independent indices, one that provides highly regarded credit data, and valuations. Other providers may include an established rating agency, or an entity that is a leading provider of credit information, or an investment bank that is experienced at creating indices and who has expertise and credibility in the credit ratings industry.

Step 2 entails producing a benchmark multi-credit index on a defined economic sector by breaking the main index into ten industry sectors established by an index provider or rating agency. Each defined sectored credit index can serve as a point of reference to measure and track the market trends in the line of credit for several institutions in a related industry. The indexed sector can capture individual credit default swap transactions to compile an industry sector CDS index (Step 3) and accommodate a defined set of credit default swap references that are narrow enough to be useful and specific to the market sector, but broad enough to force liquidity in a small number of contracts. In one embodiment, data of each industry sector index would consist of five-year generic par credit default swap spread costs reported in basis points for each reference in the index. In some cases, the credit components in such index may include domestic data points exclusively; other embodiments may comprise the sector index including foreign credit references as well.

Step 4 includes collecting relevant credit data by the index provider in order to maintain and publish the sector credit default swap indices on a routine basis. Each company's percentage weight of the total index sector would be recorded. The index provider would perform the appropriate quantitative manipulation of the data according to a pre-determined index methodology (Step 5). In one embodiment, this weight of a company in an index sector could be divided by the total weight of the companies in the sector index. The market value of the industry sector CDS index for a given day is equal to the sum across all stocks in the economic sector index for which CDS costs are available of each company's adjusted weight multiplied by each company's CDS cost. The compiled CDS indices can also include, but not be limited to, information on each individual credit default swap transacted such as reference entities and their obligations, coupon amounts, maturity and other relevant credit information including factors like constant maturity rules for corporate reorganization etc. Furthermore, the compiled index may vary one or many of the credit reference components listed over time. In these situations, the index would simply adjust its base levels to net zero changes to the listed references.

The combined effects of Steps 1-5 form the basis of a full-bodied, liquid novel marketplace capable of providing sectored credit default swap indices for the market of credit default swaps, and, thus, further providing superior efficiency to the entire credit derivatives market. The implementation of these indices, in turn, enables the attraction of natural participants in the existing credit default markets that will provide adequate liquidity to create a successful sectored marketplace. One example of a natural participant in the sectored CDS markets involves banks hedging credit risk exposures in their loan portfolios. Other examples of natural participants include hedge funds, investment banks, and major insurance companies looking to reduce credit risk exposure inherent in their underwriting process without having to sell their credit assets, or trade around relative value of the sectored CDS products versus other related instruments such as single credit default swaps, broadly indexed credit default swap products, and collateralized debt obligations, or even trade sectors against each other.

Upon the establishment of the sector indices, Step 6 of the present invention involves creating derivative products based on each of the defined sectored credit default indices. The tradable derivatives can be structured as listed contracts as well as off-exchange or over-the-counter between two or more derivative counterparties. The tradable derivatives may also include the use of futures contracts based on the described indices suggested whereby an investing member can lock a particular future index value and hedge his or her exposure to risk associated with the credit references listed in the indices. In a similar fashion, the use of index options can provide compensation if the credit default index increases or drops above or below a predetermined price level, offering subsequent risk protection or speculative opportunities to the investor.

In one embodiment, derivative contracts are created to transfer credit risk between parties (Step 7(a)). For example, a buying member pays a periodic payment to the credit risk seller, such as LIBOR, plus a number of basis points (bps), or a premium, in return for the total return of the specified sector index. Alternatively, as described by Step 7(b), a selling member receives the periodic premium for credit default protection in return for the value change or receives the return of the sector index. The payment for the return of the sector index corresponds to any appreciation or depreciation in the market value of the sectored index.

The traded derivative products may also include total return swap transactions where one party agrees to pay the other the “total return” of the underlying sectored CDS index, in return for receiving a stream of cash flows. An investor looking to match the performance of the CDS indices could enter into a Total Return Swap based upon the sectored CDS index for a number of months or years. On a periodic basis, say every month, or as established by the contracted terms, the investing member could receive the total return of the sectored CDS index and, in turn, pay a prime reference rate (LIBOR or other) plus a number of basis points. By using these type of derivatives, the investing member can reproduce the returns of the index at an expense corresponding to the amount of the number of basis points above the prime reference rate used.

A classic exchange-listed model may be used for exchanging the derivatives against the sector CDS indices, with the credit derivative products structured as listed contracts, such as other more traditional equity index futures. Alternatively, an over-the-counter platform can be used, wherein participants take counterparty risk and whereby trading and clearing is processed away from an exchange, allowing full product flexibility. Accordingly, a dealer of OTC or other products would monitor all positions taken against the sectored CDS indices, or an exchange clearing facility would provide margin requirements and credit assurance, holding the collaterals when suitable (Step 8). Step 9 consists of settling of derivatives against the proposed sectored CDS indices. All index derivatives traded against the sectored CDS indices would, preferably, be cash settled, with no physical delivery upon expiration. Thus a designated clearing facility would provide an organized structure for the settlement of all payment obligations derived from all trading positions and transfer the resolved obligations between the two parties performing the trade. In another embodiment, a dealer would facilitate required cash flow to counterparties to a specific transaction.

Some embodiments of the proposed sector credit default swap indices are intended to create a set of trading opportunities bridging the worlds of corporate bonds and credit default swaps (CDS), sector exchange-traded funds (ETFs) and index options. The Sector CDS products are designed to duplicate flexibly—with the flexibility defined by the presence of individual corporate CDS—the industry sector exposure and market capitalizations provided by S&P and accepted throughout the equity world. They are not designed to replace, compete with or supplant existing CDS index products. Embodiments of the sector credit default swap indices described herein can bring greater depth, volume and liquidity to the existing CDS market by creating a demand for the individual bonds and CDS instruments to trade against the CDS Indices, the Select SPDRs and the Select SPDR index options.

Accordingly, the present invention provides a method for establishing a credit default swap index on a defined economic sector. A reference economic sector is identified by an index provider. A multi-credit corporate index is established for the reference economic sector. Individual credit default swap (CDS) transactions and the multi-credit corporate index are used to compile an industry sector CDS index for the reference economic sector. At least one issue or credit reference in the industry sector CDS index is weighted differently, relative to the weight of other issues or credit references in the industry sector CDS index. A percentage weight of each issue or credit reference in the industry sector CDS index is publicly disseminated. A value of the industry sector CDS index is updated on periodic basis. Structured credit instruments are issued by a dealer based on the industry sector CDS sector index. The structured credit instruments include at least one of the following provisions: (i) an obligation of a buyer to pay a periodic premium or a return of the industry sector CDS index to a seller; and (ii) a right by a seller to receive a periodic premium for credit default protection or the return of the industry sector CDS index. Trading positions with respect to the structured credit instruments are monitored by a dealer. The structured credit instruments are settled against the industry sector CDS index.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

We claim:

1. A method for establishing a credit default swap index on a defined economic sector, comprising the steps of:
(a) identifying a reference economic sector by an index provider;
(b) establishing a multi-credit corporate index for the reference economic sector;
(c) capturing individual credit default swap (CDS) transactions and using the multi-credit corporate index to compile an industry sector CDS index for the reference economic sector; wherein at least one issue or credit reference in the industry sector CDS index is weighted differently, relative to the weight of other issues or credit references in the industry sector CDS index;
(d) publicly disseminating a percentage weight of each issue or credit reference in the industry sector CDS index;
(e) updating a value of the industry sector CDS index on periodic basis;
(f) issuing structured credit instruments based on the industry sector CDS sector index by a dealer;
(g) wherein the structured credit instruments include at least one of the following provisions: (i) an obligation of a buyer to pay a periodic premium or a return of the industry sector CDS index to a seller; and (ii) a right by a seller to receive a periodic premium for credit default protection or the return of the industry sector CDS index;
(h) monitoring trading positions by the dealer with respect to the structured credit instruments; and
(i) settling the structured credit instruments against the industry sector CDS index.

2. The method of claim 1, wherein the industry sector CDS index is divided into a set of industry sub-sectors.

3. The method of claim 1, wherein data used for compiling the industry sector CDS index comprises generic par credit default swap spread (CDS) costs reported for each reference value in the index, if and when available.

4. The method of claim 1, wherein the industry sector CDS index is a market capitalization-weighted combination of available credit default swap costs in basis points for all credit references of the reference economic sector.

5. The method of claim 1, wherein each issue or credit reference's percentage weight of the industry sector CDS index on a market capitalization basis is recorded and updated periodically.

6. The method of claim 5, wherein the weight is divided by a total weight of companies in the reference economic sector.

7. The method of claim 1, wherein the value of the industry sector CDS index for a given day is equal to a sum across all companies in the reference economic sector for which CDS costs are available of each company's adjusted weight multiplied by each company's CDS cost.

8. The method of claim 5, wherein the industry sector CDS index is a market capitalization-weighted combination of available credit default swap costs in basis points for all credit references of the reference economic sector.

9. The method of claim 5, wherein the industry sector CDS index is a market price-weighted combination of available credit default swap costs in basis points for all credit references of the reference economic sector.
